(19) United States
(12) Patent Application Publication
(10) Pub. No.: US 2020/0346351 A1
(43) Pub. Date: Nov. 5, 2020

(54) SYSTEMS AND METHODS FOR PICKING UP AND TRANSFERRING ITEMS USING A ROBOTIC DEVICE

(71) Applicant: Walmart Apollo, LLC, Bentonville, AR (US)

(72) Inventors: James Benjamin Edwards, Fayetteville, AR (US); Paul E. Durkee, Centerton, AR (US)

(21) Appl. No.: 16/852,687

(22) Filed: Apr. 20, 2020

Related U.S. Application Data
(60) Provisional application No. 62/840,526, filed on Apr. 30, 2019.

(51) Int. Cl. B25J 9/16; B65G 1/137

(52) U.S. Cl. CPC B25J 9/1697; B65G 1/1373

(57) ABSTRACT

There is provided systems and methods for picking up and transferring a variety of different types of merchandise, such as at shopping facilities. In one form, the system includes: a shopping facility with a merchandise order assembly area; an automated retrieval for transporting merchandise to the merchandise order assembly area; an image sensor; at least one robotic device including a plurality of end effectors for picking up merchandise; and a merchandise database identifying surface areas suitable for engagement with end effectors. The system also includes a control circuit that identifies a merchandise item being transported, receives images of the merchandise item and determines its orientation, chooses a surface area of the merchandise item for engagement, selects an end effector to be used to engage the merchandise item, and instructs movement and transfer of the merchandise item by the robotic device.

### CROSS-REFERENCE TO RELATED APPLICATION

This application claims the benefit of U.S. Provisional Application No. 62/840,526, filed Apr. 30, 2019, which is incorporated by reference in its entirety herein.

### TECHNICAL FIELD

This invention relates generally to robotic devices, and more particularly, to robotic devices used to pick up and transfer a variety of types of merchandise items.

### BACKGROUND

In the retail setting, customers are increasingly placing merchandise orders that are then assembled and made ready for pick up at shopping facilities. In this regard, it is desirable to be able to assemble the merchandise orders efficiently using an automated retrieval system. The automated retrieval system may collect some or all of the ordered merchandise in a storage area and then transport it to an order assembly area by a transport conveyance, such as by a conveyor assembly or by an autonomous ground vehicle.

Once some or all of the ordered merchandise has been transported to the order assembly area, it may then be transferred to an order tote or container for eventual pick up by the customer. In this regard, it is desirable to use a robotic device in an automated system to transfer the arriving merchandise items to the order tote or container. Further, it is desirable to use one or more robotic devices with a variety of end effectors so as to be able to engage and transfer a variety of different types of merchandise items. There is a need for an automated system using one or more robotic devices that can determine the orientation of a merchandise item and determine appropriate surfaces of the merchandise item for engagement and transfer by an appropriate end effector.

### BRIEF DESCRIPTION OF THE DRAWINGS

Disclosed herein are embodiments of systems, apparatuses and methods using robotic devices used to pick up and transfer a variety of types of merchandise items. This description includes drawings, wherein:

FIG. 1 is a schematic diagram in accordance with some embodiments;

FIG. 2 is a block diagram in accordance with some embodiments;

FIG. 3 is a block diagram in accordance with some embodiments;

FIG. 4 is a schematic diagram in accordance with some embodiments;

FIG. 5 is a block diagram in accordance with some embodiments;

FIG. 6 is a block diagram in accordance with some embodiments;

FIG. 7 is a schematic diagram in accordance with some embodiments;

FIG. 8 is a flow diagram in accordance with some embodiments; and

FIG. 9 is a block diagram in accordance with some embodiments.

Elements in the figures are illustrated for simplicity and clarity and have not necessarily been drawn to scale. For example, the dimensions and/or relative positioning of some of the elements in the figures may be exaggerated relative to other elements to help to improve understanding of various embodiments of the present invention. Also, common but well-understood elements that are useful or necessary in a commercially feasible embodiment are often not depicted in order to facilitate a less obstructed view of these various embodiments of the present invention. Certain actions and/or steps may be described or depicted in a particular order of occurrence while those skilled in the art will understand that such specificity with respect to sequence is not actually required. The terms and expressions used herein have the ordinary technical meaning as is accorded to such terms and expressions by persons skilled in the technical field as set forth above except where different specific meanings have otherwise been set forth herein.

### DETAILED DESCRIPTION

The following description is not to be taken in a limiting sense, but is made merely for the purpose of describing the general principles of exemplary embodiments. Reference throughout this specification to “one form,” “one embodiment,” “an embodiment,” “some embodiments”, “an implementation”, “some implementations”, “some applications”, or similar language means that a particular feature, structure, or characteristic described in connection with the embodiment is included in at least one embodiment of the present invention. Thus, appearances of the phrases “in one embodiment,” “in an embodiment,” “in some embodiments”, “in some implementations”, and similar language throughout this specification may, but do not necessarily, all refer to the same embodiment.

Generally speaking, pursuant to various embodiments, systems, apparatuses and methods are provided herein using robotic devices to pick up and transfer a variety of types of merchandise items. In one form, the system comprises: a shopping facility comprising a merchandise order assembly area configured for assembly of part or all of a merchandise order; an automated retrieval system configured to retrieve and transport merchandise to the merchandise order assembly area; an image sensor configured to capture images of a merchandise item being transported to the merchandise order assembly area; at least one robotic device at the merchandise order assembly area configured to pick up and move the merchandise item, the at least one robotic device including a plurality of end effectors mounted to the at least one robotic device, each end effector configured to engage predetermined surfaces of different types of merchandise; a merchandise database containing a plurality of records of merchandise at the shopping facility, each merchandise record identifying a set of surface areas on the merchandise corresponding to each end effector and suitable for engagement with the corresponding end effector; and a control circuit communicatively coupled to the image sensor, the at least one robotic device, and the merchandise database, the control circuit configured to: identify the merchandise item being transported to the merchandise order assembly area; receive, from the image sensor, the images of the merchandise item being transported to the merchandise order assembly area; determine, from the images, an orientation of the merchandise item relative to the at least one robotic device; determine, from the merchandise database, the set of surface areas of the merchandise item suitable for engagement with end effectors; choose one of the set of surface areas of the merchandise item suitable for engagement based, at least in part, on the orientation of the merchandise item relative to the at least one robotic device; select one of the plurality of end effectors of the at least one robotic device to be used to engage the merchandise item; instruct movement of the at least one robotic device so as to cause the selected end effector to engage the chosen surface area of the merchandise item; and instruct, following engagement of the selected end effector with the chosen surface area of the merchandise item, movement of the at least one robotic device to transfer the merchandise item to a receiving location.

In some implementations, in the system, he automated retrieval system comprises: a plurality of containers configured to contain merchandise in a merchandise storage area in the shopping facility; and a transport conveyance configured to transport containers between the merchandise storage area and the merchandise order assembly area. In some implementations, the transport conveyance comprises at least one of a conveyor assembly and an autonomous ground vehicle. In some implementations, the system further comprises a plurality of robotic devices and a plurality of merchandise order assembly areas in the shopping facility, each merchandise order assembly area corresponding to a different range of merchandise transported to that merchandise order assembly area. In some implementations, the system further comprises: a first robotic device in a first merchandise order assembly area configured for pick up and transfer of merchandise in a first, ambient temperature range; a second robotic device in a second merchandise order assembly area configured for pick up and transfer of merchandise in a second, chilled temperature range; and a third robotic device in a third merchandise order assembly area configured for pick up and transfer of merchandise in a third, frozen temperature range. In some implementations, the plurality of end effectors comprises at least one of a plurality of suction cups of different sizes and a plurality of grasping arms with fingers of different lengths. In some implementations, each merchandise record identifies a no pickup set of surface areas on the merchandise item for surface areas that are not suitable for engagement. In some implementations, the system further comprises a plurality of robotic devices at the merchandise order assembly area, each robotic device including a different, predetermined set of end effectors mounted to each robotic device; wherein the control circuit is configured to select and instruct one of the plurality of robotic devices to pick up and transfer the merchandise item. In some implementations, the image sensor is configured to capture images of an attempted pick up of the merchandise item by the selected end effector; and the control circuit is configured to: receive, from the image sensor, the images of the attempted pick up of the merchandise item by the selected end effector; determine if the selected end effector has successfully picked up the merchandise item; and if the selected end effector has not successfully picked up the merchandise item: determine an updated orientation of the merchandise item relative to the at least one robotic device; determine, from the merchandise database, the set of surface areas of the merchandise item suitable for engagement with end effectors; determine one of the set of surface areas of the merchandise item suitable for engagement based, at least in part, on the updated orientation of the merchandise item relative to the at least one robotic device; select a different end effector of the at least one robotic device to be used to engage the merchandise item; instruct movement of the at least one robotic device so as to cause the different end effector to engage the determined surface area of the merchandise item; and instruct, following engagement of the different end effector with the determined surface area of the merchandise item, movement of the at least one robotic device to transfer the merchandise item to the receiving location.

In another form, there is provided a method for picking up and transferring a variety of different types of merchandise in shopping facilities, the method comprising: providing a merchandise order assembly area in a shopping facility configured for assembly of part or all of a merchandise order; retrieving and transporting merchandise to the merchandise order assembly area; capturing images of a merchandise item being transported to the merchandise order assembly area; by at least one robotic device at the merchandise order assembly area, picking up and moving the merchandise item, the at least one robotic device including a plurality of end effectors mounted to the at least one robotic device, each end effector configured to engage predetermined surfaces of different types of merchandise; storing a plurality of records of merchandise at the shopping facility, each merchandise record identifying a set of surface areas on the merchandise corresponding to each end effector and suitable for engagement with the corresponding end effector; and by a control circuit: identifying the merchandise item being transported to the merchandise order assembly area; receiving the images of the merchandise item being transported to the merchandise order assembly area; determining, from the images, an orientation of the merchandise item relative to the at least one robotic device; determining the set of surface areas of the merchandise item suitable for engagement with end effectors; choosing one of the set of surface areas of the merchandise item suitable for engagement based, at least in part, on the orientation of the merchandise item relative to the at least one robotic device; selecting one of the plurality of end effectors of the at least one robotic device to be used to engage the merchandise item; instructing movement of the at least one robotic device so as to cause the selected end effector to engage the chosen surface area of the merchandise item; and instructing, following engagement of the selected end effector with the chosen surface area of the merchandise item, movement of the at least one robotic device to transfer the merchandise item to a receiving location.

In another form, there is provided a system for picking up and transferring a variety of different types of merchandise, the system comprising: an image sensor configured to capture images of a merchandise item; at least one robotic device configured to pick up and move the merchandise item, the at least one robotic device including a plurality of end effectors mounted to the at least one robotic device, each end effector configured to engage predetermined surfaces of different types of merchandise; a merchandise database containing a plurality of records of merchandise, each merchandise record identifying a set of surface areas on the merchandise corresponding to each end effector and suitable for engagement with the corresponding end effector; and a control circuit communicatively coupled to the image sensor, the at least one robotic device, and the merchandise database, the control circuit configured to: identify the merchandise item; receive, from the image sensor, the images of the merchandise item; determine, from the images, an orientation of the merchandise item relative to the at least one robotic device; determine, from the merchandise database, the set of surface areas of the merchandise item suitable for engagement with end effectors; choose one of the set of surface areas of the merchandise item suitable for engagement based, at least in part, on the orientation of the merchandise item relative to the at least one robotic device; select one of the plurality of end effectors of the at least one robotic device to be used to engage the merchandise item; instruct movement of the at least one robotic device so as to cause the selected end effector to engage the chosen surface area of the merchandise item; and instruct, following engagement of the selected end effector with the chosen surface area of the merchandise item, movement of the at least one robotic device to transfer the merchandise item to a receiving location.

This disclosure relates generally to an automated system using robotic devices to transfer various types of merchandise/products. More specifically, it involves a system employing robotic devices that can move a product from a first location to a second location. For each product, especially those with complex or variable geometries (flaps, flat surfaces, large aspect ratios, blister packs, curved surfaces, etc.), different robotic devices and/or end effectors on the robotic device(s) must be selected to most efficiently transfer the product. Further, this selection of robotic device(s) and/or end effectors will depend on the orientation of the product to be transferred by the robotic device. The term “end effectors” is used broadly herein and refers generally to manipulators and/or attachments that are fixedly or removably mounted to robotic devices.

In one context, this automated system employing robotic device(s) may be used in a retail setting. For example, the robotic device(s) may be used in a shopping facility or store as part of an approach for receiving merchandise orders from customers and then assembling them for pick up by customers. In this example, it is contemplated that some or all of the merchandise may be transported to a merchandise assembly area in the shopping facility where it may then be transferred to one or more order totes or containers, which will eventually be picked up by customers at the shopping facility. The robotic device(s) may be used in the merchandise transfer process.

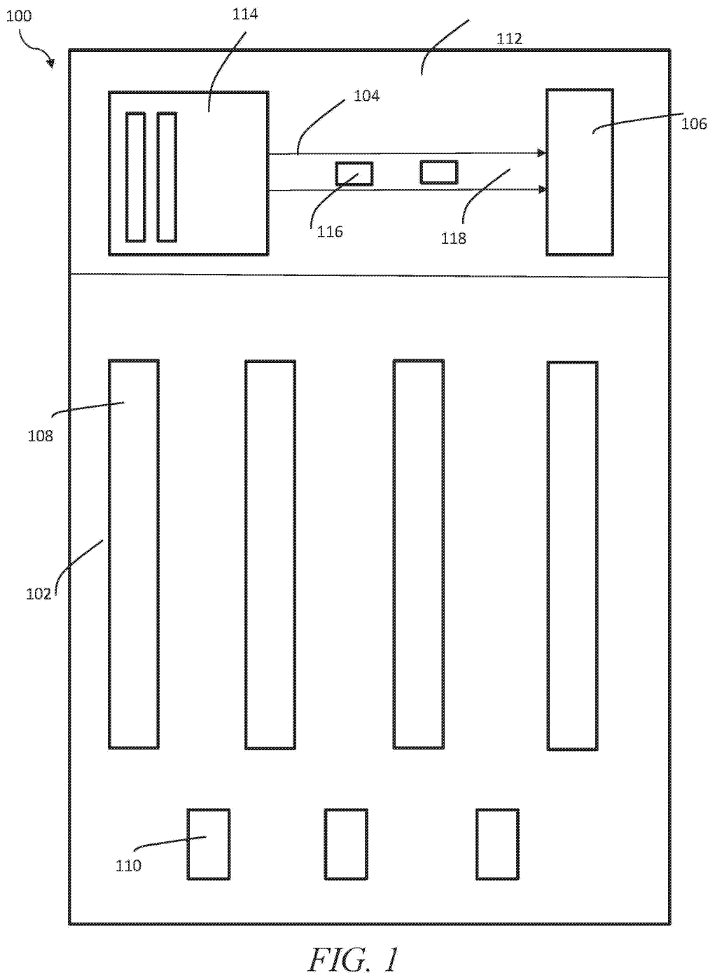

Referring to FIG. 1, there is shown part of a system 100 for picking up and transferring a variety of different types of merchandise at a shopping facility 102. It is generally contemplated that the system 100 may use one or more robotic devices at the shopping facility 102 to pick up merchandise of various sizes, shapes, and orientations. It is also contemplated that the merchandise may be transported using an automated retrieval system 104, and the one or more robotic devices are employed to move the merchandise to a tote/container (such as for pick up by a customer).

The system 100 includes a shopping facility 102 that includes a merchandise order assembly area 106 (or station). It is generally contemplated that the shopping facility 102 may be any of various types of facilities at which merchandise is located, such as, for example, retail stores, distribution centers storing merchandise, etc. FIG. 1 shows one example of a shopping facility 102 in the form of a retail store. This shopping facility 102 includes shelves/aisles 108 on which merchandise may be arranged and point-of-sale checkout areas 110 where purchase of merchandise may be completed.

The merchandise order assembly area 106 is configured for assembly of part or all of a merchandise order, which may be picked up by customers. In one form, this merchandise order assembly area 106 may be disposed in a separate backroom area 112 of the shopping facility 102. It is generally contemplated that merchandise may be transported to the merchandise order assembly area 106 by an automated retrieval system 104 and/or manually (such as by store employees). The merchandise order assembly area 106 may be of any of various sizes and arrangements so as to allow transfer of merchandise to order totes/containers for pick up customers. The merchandise order assembly area 106 may also serve as a customer pick up area at the shopping facility 102 or the customer pick up area may be at a different location.

The system 100 includes an automated retrieval system 104 that is configured to retrieve and transport merchandise to the merchandise order assembly area 106. It is contemplated that the automated retrieval system 104 may transport only a portion (and not necessarily all) of the merchandise being transported to the merchandise order assembly area 106. In this particular form, some or all of the merchandise may be transported from a merchandise storage area 114 to the merchandise order assembly area 106 in the backroom area 112 of the shopping facility 102.

The automated retrieval system 104 may include a plurality of containers (or storage totes) 116 configured to contain merchandise in a merchandise storage area 114 in the shopping facility 102. It may further include a transport conveyance 118 configured to transport the containers 116 between the merchandise storage area 114 and the merchandise order assembly area 106. In one form, the transport conveyance may be in the form of one or more conveyor assemblies 118.

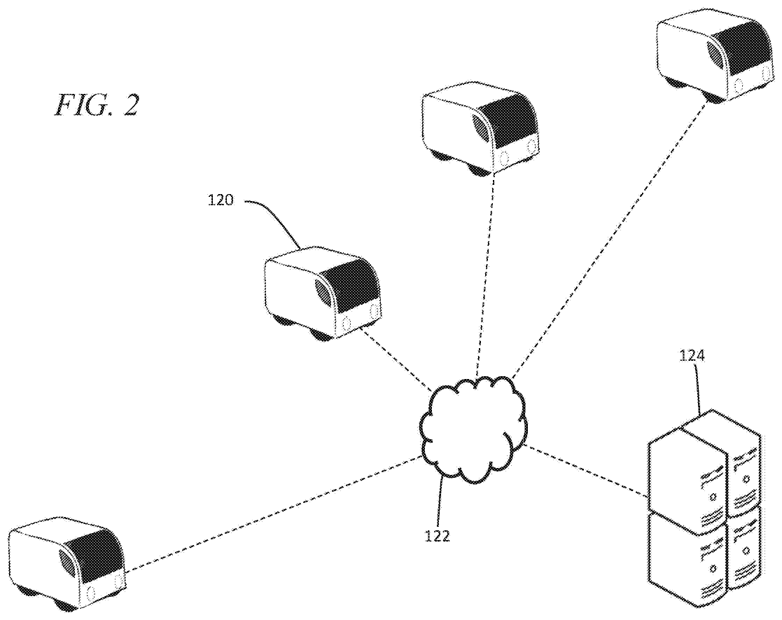

Alternatively, or in addition to the conveyor assembl(ies), the transport conveyance 118 may employ one or more autonomous ground vehicles 120 to transport some or all of the merchandise. Referring to FIG. 2, there is shown an example in which multiple AGVs 120 move about the shopping facility 102 and operate autonomously. It is generally contemplated that the multiple AGVs 120 may travel back and forth between the merchandise storage area 114 and the merchandise order assembly area 106 at the shopping facility 102. Under this approach, to facilitate coordination of the AGVs 120 in transporting different merchandise, the AGVs 120 may communicate over a network 122. The system 100 may include a central computer system 124 (or control circuit) at the shopping facility 102 accessible by one or more of the AGVs 120 over the network 122.

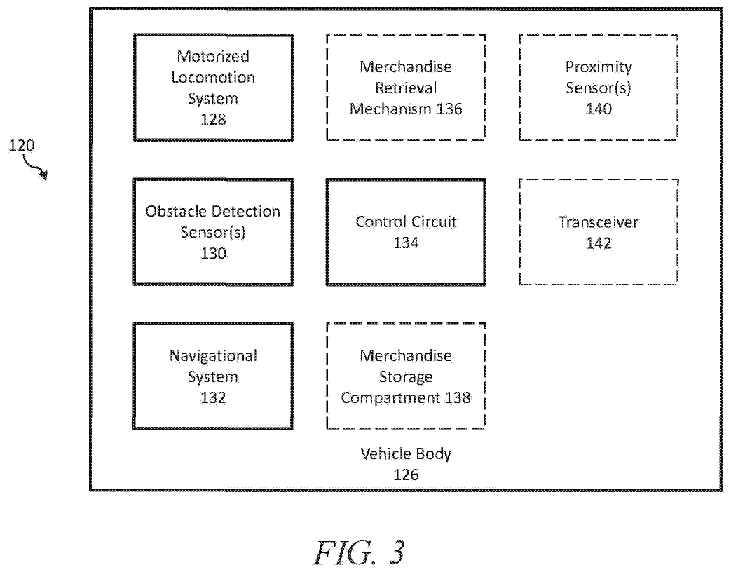

Referring now to FIG. 3, it is generally contemplated that the AGV 120 includes certain components in and about its vehicle body 126 that allow it to convey merchandise and to travel about the shopping facility 102. In one form, each AGV 120 includes a motorized locomotion system 128, at least one obstacle detection sensor 130, a navigational system 132, and an AGV control circuit 134. It is contemplated that the AGV 120 may also include other components, such as, without limitation, a merchandise retrieval mechanism 136, a merchandise storage compartment 138, proximity sensor(s) 140, and a transceiver 142. It is generally contemplated that the AGVs 120 are generally interchangeable with one another.

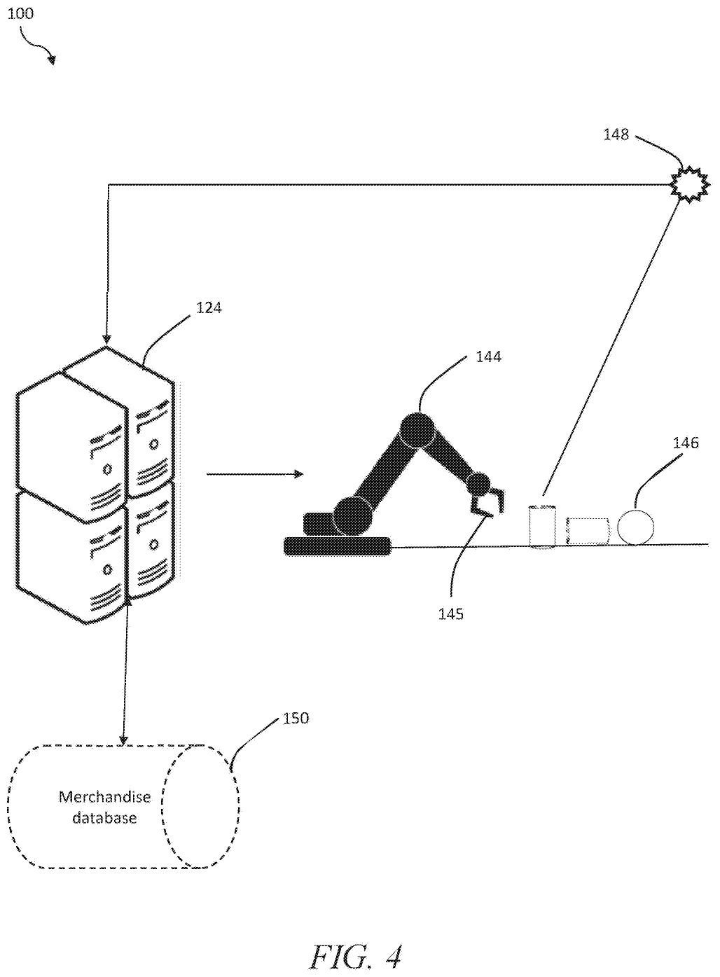

Referring to FIG. 4, there is shown a schematic of part of the system 100 involving a robotic device 144 and its interaction with certain other components of the system 100. It is generally contemplated that the robotic device 144 is disposed at the merchandise order assembly area 106 and is configured to pick up and move a variety of merchandise items 146 of various shapes, sizes, and orientations. In one form, the robotic device 144 may be a robotic arm that is anchored to a fixed position in the merchandise order assembly area 106 or that is mounted on a mobile platform for movement within the merchandise order assembly area 106. In another form, the robotic device 144 may be a cartesian coordinate robot that may be mounted for movement along any of three different axes. As used herein, it should be understood that “a robotic device” is used broadly herein and may mean one or more than one as it is contemplated that a merchandise order assembly area 106 (or station) may have one or more robotic devices 144 that each be equipped with one or more end effectors 145. As should be understood, a variety of different types of robotic devices may be used herein.

The system 100 also includes an image sensor 148 that is configured to capture images of a merchandise item 146 being transported to the merchandise order assembly area 106. As can be seen, the image sensor 148 is preferably mounted and disposed in a manner such that it is directed to capture images of the merchandise item 146 when it is in a position to be picked up by the robotic device 144. In one form, the image sensor 148 may be mounted above the transport conveyor 118 (which may be a conveyor assembly). The image sensor 148 captures and transmits images of the size, shape, and orientation of the merchandise item 146 so that a determination can be made as to which end effector 145 should be used to pick up the merchandise item 146. The image sensor 148 may be any of various types of cameras, video devices, or other optical instruments suitable for capturing the orientation of the merchandise item 146.

The system 100 further includes a merchandise database 150 containing a plurality of records of merchandise at the shopping facility 102. Each merchandise record identifies a set of surface areas on the merchandise item 146 corresponding to each end effector 145 and that is suitable for engagement with the corresponding end effector 145. The end effectors 145 that may be appropriate may differ for the different surface areas. For example, if the merchandise item 146 is oriented right side up, one type of end effector (such as a certain size of suction cup) may be appropriate for engaging the top of the merchandise item 146 (possibly, for example, because a relatively large surface area is exposed to the robotic device 144). However, if the merchandise item 146 is oriented on its side, a second (and different) type of end effector 145 (such as a certain size of grasping arm with fingers) may be appropriate for engaging the side of the merchandise item 146 (possibly, for example, because a relatively small surface area is exposed to the robotic device 144). It is generally contemplated that the various surface areas of the different merchandise items have been mapped and stored in the merchandise database 150 to match surface areas with suitable end effectors 145. In one form, the merchandise records would identify different surface areas on the merchandise item 146 that are suitable pick up and the corresponding end effector(s) 145 that should be used.

One example of a merchandise item 146 with surface areas matched to suitable end effectors 145 is that of a soup can with a pull tab. Normally, a soup can may be lifted by a suction cup engaging the can's end, but the pull tab results in a non-smooth surface that cannot be sealed and thus may not be successfully lifted with suction. Further, whether or not this feature is seen and becomes a factor depends on the orientation of the merchandise item 146 relative to the robotic device 144. In one form, it is contemplated that the merchandise item 146 may be in any of various orientations in a container or storage tote (and may have been disturbed from its initial position and orientation in the container). So, if the soup can is in a right-side-up orientation when at the robotic device 144, for example, the pull tab will be seen and a grasping arm/gripper may be required. However, if it is on its head or on its side, suction may be the desirable end effector 145 to be used to engage and transfer the item.

Another example of a merchandise item 146 where the end effector selected depends on the orientation of the item 146 is a rice package. In this example, if the rice package is in a right-side-up orientation when at the robotic device 144, the merchandise database 150 may indicate that it should be gripped and that a certain type of grasping arm/gripper should be used on the exposed surface area. However, if the rice package is laying down, this orientation may call for a different end effector to be used, such as, for example, a certain size of suction cup.

The robotic device 144 includes a plurality of end effectors mounted to the robotic device 144. Each of the end effectors is configured to engage predetermined surfaces of different types of merchandise. The end effectors may be any of various types, shapes, and sizes, including, without limitation: grasping arms with fingers (or grippers/claws that physically grasp the merchandise item 146); suction cups (which attract the merchandise item by suction); end effectors that attract the merchandise item 146 (such as by magnetism or electroadhesive/electrostatic principles); and penetrative end effectors (such as needs that penetrate or pierce the merchandise item 146).

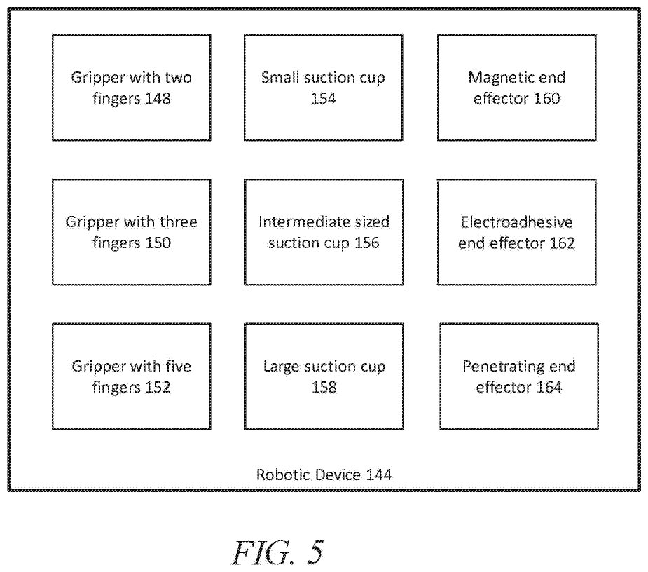

It is generally contemplated that the robotic device 144 may include a plurality of end effectors of the same type (various grasping arms with fingers) or of different types (grasping arms with fingers and suction cups). For example, as shown in FIG. 5, the robotic device 144 might include some or all of the following: three types of grasping arms (a grasping arm with two fingers 149, a grasping arm with three fingers 150, and a grasping arm with five fingers 152); three types of suction cups (a small suction cup 154 for light items and/or small surface areas; an intermediate sized suction cup 156; and a large suction cup 158 for heavier items and/or large surface areas); a magnetic end effector 160; an electroadhesive end effector 162; and a penetrating end effector 164.

Further, the system 100 may use multiple robotic devices 144 with each robotic device 144 including a different type of end effector 145. Different robotic devices 144 may include different numbers and types of end effectors 145, such as one or more of those shown, without limitation, in FIG. 5. For example, a first robotic device 144 may only include various grasping arms with fingers, while a second robotic device 144 may include various sizes of suction cups. In one form, the plurality of end effectors may include at least one of a plurality of suction cups of different sizes and a plurality of grasping arms with fingers of different lengths. In other words, the system 100 may include a plurality of robotic devices 144 at the merchandise order assembly area 106 with each robotic device 144 including a different, predetermined set of end effectors 145 mounted to each robotic device 144, wherein the control circuit 124 is configured to select and instruct one of the plurality of robotic devices 144 to pick up and transfer the merchandise item 146. It is also contemplated that multiple robotic devices 144 do not necessarily have different end effectors 145 (and, in one form, may include overlapping end effectors 145). For example, in one form, a first robotic device 144 may be set up to handle relatively light merchandise (i.e., merchandise below a certain threshold weight), while a second robotic device 144 is set up to handle relatively heavy merchandise (i.e., above a certain threshold weight). As should be understood, other purposes and arrangements for the use of multiple robotic devices 144 with various types of end effectors are also possible.

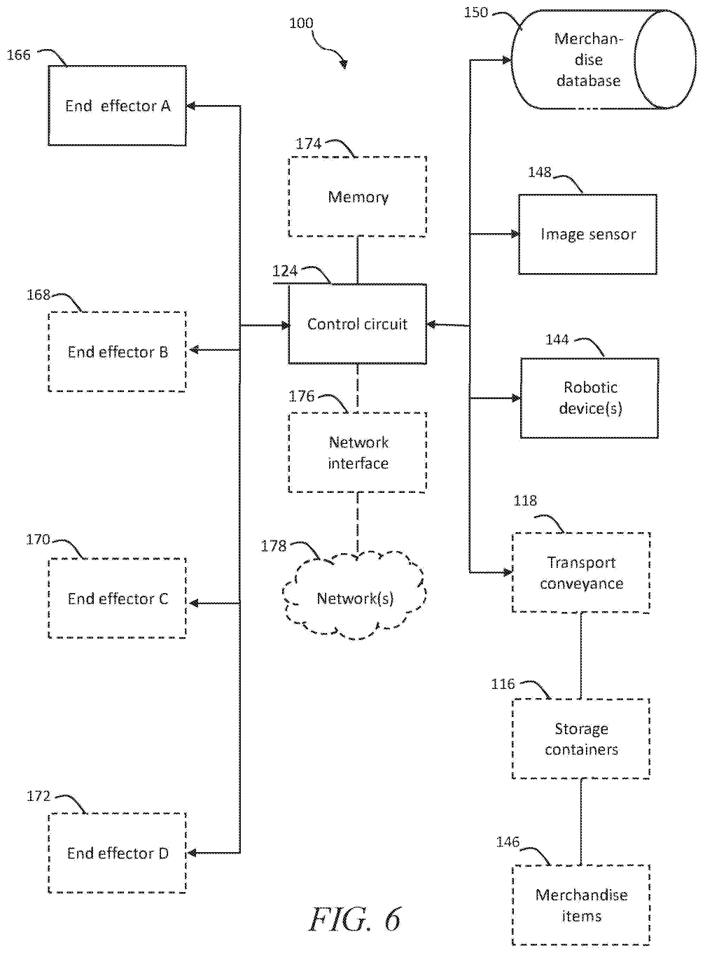

As shown in FIG. 6, a control circuit 124 governs the operation of the system 100. The control circuit 124 may be in wireless communication with a certain number of end effectors (end effector A 166, end effector B 168, end effector C 170, and end effector D 172) and may control the selection of the end effector of the robotic device(s) 144 to be used for moving a merchandise item 146. As described herein, the language “control circuit” refers broadly to any microcontroller, computer, or processor-based device with processor, memory, and programmable input/output peripherals, which is generally designed to govern the operation of other components and devices. It is further understood to include common accompanying accessory devices, including memory, transceivers for communication with other components and devices, etc. These architectural options are well known and understood in the art and require no further description here. The control circuit 124 may be configured (for example, by using corresponding programming stored in a memory as will be well understood by those skilled in the art) to carry out one or more of the steps, actions, and/or functions described herein.

As shown in FIG. 6, the control circuit 124 is coupled to a memory 174 and may be coupled to a network interface 176 and network(s) 178. The memory 174 can, for example, store non-transitorily computer instructions that cause the control circuit 124 to operate as described herein, when the instructions are executed, as is well known in the art. Further, the network interface 176 may enable the control circuit 124 to communicate with other elements (both internal and external to the system 100). This network interface 176 is well understood in the art. The network interface 176 can communicatively couple the control circuit 124 to whatever network or networks 178 may be appropriate for the circumstances. The control circuit 124 may be in communication with the server of the shopping facility 102 and may make use of cloud databases and/or operate in conjunction with a cloud computing platform.

The control circuit 124 identifies the merchandise item 146 being transported to the merchandise order assembly area 106. This identification may be accomplished in a number of ways and at various times and stages. For example, the merchandise item 146 may include some sort of identification label (such as a barcode label) that may be scanned or read at any of various locations (such as in the merchandise storage area 114, at or on the transport conveyance 118, or in the merchandise order assembly area 106). Alternatively, as another example, the merchandise item 146 may be recognized from the images captured by the image sensor 148 using image processing techniques to match the merchandise item 146 captured in the images with images of known merchandise items.

The control circuit 124 receives the images of the merchandise item 146 being transported to the merchandise order assembly area 106. It is generally contemplated that, at least, some of the images will be of the merchandise item 146 in a position at or near the robotic device 144. These images will show the orientation of the merchandise item 146, which will, in turn, determine the surface area of the merchandise item 146 to be engaged (or otherwise utilized) and the end effector 145 to be selected. In other words, the control circuit 124 determines, from the images, an orientation of the merchandise item 146 relative to the robotic device 144.

The control circuit 124 further determines, from the merchandise database 150, the set of surface areas of the merchandise item 146 suitable for engagement with end effectors. It is generally contemplated that each merchandise record may include only a limited number of surface areas that are suitable for engagement by any end effector 145. The merchandise record may include “no-pick” surface areas either implicitly (no end effectors 145 are associated with that surface area or particular surface areas are not included in the record) or expressly by designation (the record specifically identifies surface areas of the item 146 that are not to be engaged). In other words, in one form, each merchandise record may identify a no pickup set of surface areas on the merchandise item for surface areas that are not suitable for engagement.

Complex shaped products may have end effectors 145 associated with different locations on the surfaces of the product, and the surfaces of various products may be mapped and stored in the merchandise database 150. In one form, each location on the 3-dimensionsal surface of the merchandise item 146 may have a primary picker (end effector 145) associated with that location. This map may include alternative end effectors 145 (ones that work just as well) or secondary end effectors 145 (ones that may not be quite as effective, but that will work, if necessary).

As indicated above, the map may also include regions not to be gripped, suctioned, etc. Whereas the surface map generally assigns locations to surfaces that can be gripped successfully, the no-pick regions are ones that could result in the product being dropped or broken off if gripped there, even though the “grip” itself may be secure. One example of a not-to-be picked surface of a merchandise item 146 is a six-pack of pudding where the six cups are generally connected to one another by perforated fold lines. If any of the four individual cups on the ends are suctioned and lifted, the package may break at one of the perforations, thereby breaking off and dropping some of the individual cups of pudding. In this example, the map may include no-pick designations for the surfaces of the four end cups, may allow suction on the top of the center cups, and may allow grippers/grasping arms on the bottom of the center cups.

Next, the control circuit 124 chooses one of the set of surface areas of the merchandise item 146 suitable for engagement based, at least in part, on the orientation of the merchandise item 146 relative to the robotic device 144. So, for example, if the merchandise item 146 is in a right-side-up orientation, the accessible surface areas may be limited to the top of the item 146 or one or more sides of the item 146. In other words, the orientation of the item 146 limits the surface areas that are accessible and available to be used for pick up.

The control circuit 124 selects one of the plurality of end effectors 145 of the robotic device 144 to be used to engage the merchandise item 146. In certain circumstances, the selection options may be limited. For example, the orientation of the merchandise item 146 may indicate that it is only accessible from the top of the item 146, and there may only be one end effector 145 suitable for engagement via the top of the item 146. Alternatively, if the merchandise item 146 is only accessible form the top of the item 146, there may still be several end effectors 145 that are suitable for use for this particular merchandise item 146 in this particular orientation. As another example, the orientation of the merchandise item 146 may indicate that it is accessible from multiple locations (such as from the top or from the sides of the item 146). In this example, different end effectors 145 may be used that correspond with engagement with the different accessible surface areas of the item 146.

The control circuit 124 is also preferably configured to recognize features that are not normally associated with a specific product. This scenario may occur when a product is damaged through breaking or deformation. Modifications to a product's geometry, whether occurring intentionally or unintentionally, may render the end effectors normally associated with that product unable to perform the pick, i.e., to engage and transfer the merchandise item. The control circuit 124 will preferably recognize these features (such as by comparison to images of the merchandise item without deformities and/or by comparison to images of known deformities) and, if necessary, switch to an alternative or secondary end effector and/or switch to a different location on the product for pick up. It should be understood, that for any merchandise item that cannot be successfully picked, whether due to deformities or for whatever reason, it is contemplated that a manual backup (such as a store employee) may be useful to complete the transfer of any merchandise to the receiving location, as necessary (or the merchandise may be redirected to a manual station).

Following selection of an end effector, the control circuit 124 instructs movement of the robotic device 144 so as to cause the selected end effector 145 to engage the chosen surface area of the merchandise item 146. In other words, once a selection has been made, an attempt is made to engage the chosen surface area with the selected end effector 146. Following engagement of the selected end effector with the chosen surface area of the merchandise item, the control circuit 124 then instructs movement of the robotic device 144 to transfer the merchandise item 146 to a receiving location (such as, for example, an order tote or container for pick up by the customer).

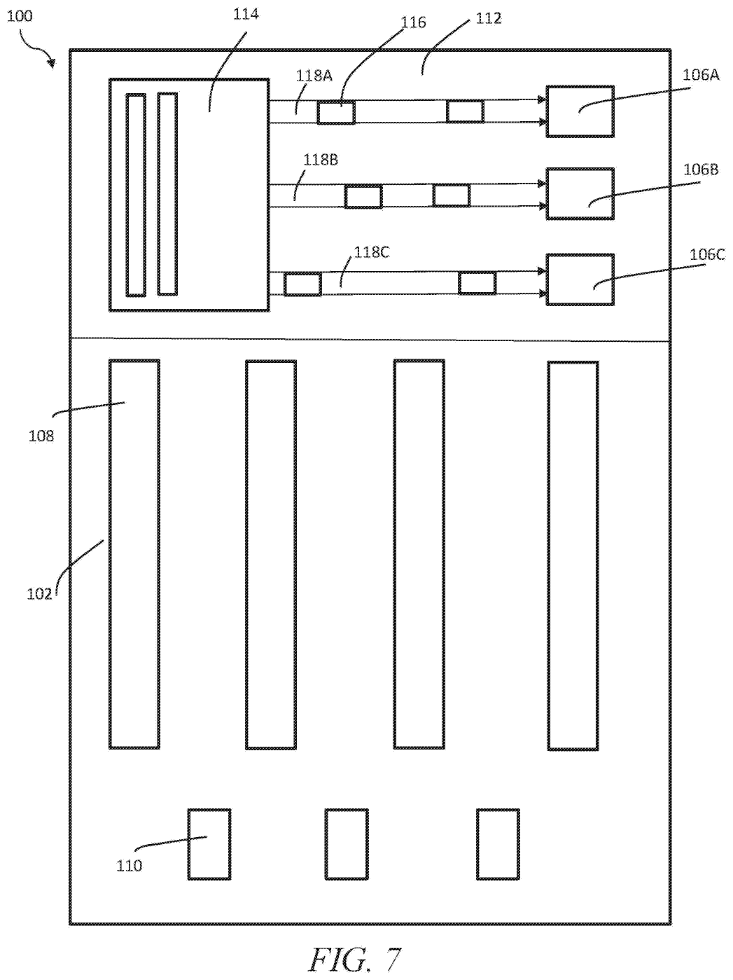

In one form, it is also contemplated that there may be multiple merchandise order assembly areas 106 (or stations) disposed about the shopping facility 102. In other words, the system 100 may include a plurality of robotic devices 144 and a plurality of merchandise order assembly areas 106 in the shopping facility 102. Further, each merchandise order assembly area 106 may correspond to a different range of merchandise transported to that merchandise order assembly area 106. As one example, as shown in FIG. 7, there may be three (or more) robotic devices 144 used at three different areas 106A, 106B, and 106C of the shopping facility 102 for merchandise having different temperature ranges and categorized as ambient, chilled, and frozen. Accordingly, in this example, the system 100 may include a first robotic device 144 in a first merchandise order assembly area 106A configured for pick up and transfer of merchandise in a first, ambient temperature range; a second robotic device 144 in a second merchandise order assembly area 106B configured for pick up and transfer of merchandise in a second, chilled temperature range (and/or including produce); and a third robotic device 144 in a third merchandise order assembly area 106C configured for pick up and transfer of merchandise in a third, frozen temperature range. The end effectors 145 at each merchandise order assembly area 106 may also vary depending on the nature of the merchandise. For example, the ambient station might include a variety of end effectors 145 to broadly include most merchandise; the frozen station may include end effectors 145 that are predominantly grasping arms with fingers (suction cups would be less effective); and the chilled or produce station might include air-filled end effectors 145 to lightly engage the produce and thereby avoid bruising produce (such as a tomato or an apple). Further, the system 100 may include additional merchandise order assembly areas 106, such as for specialty items. In the example shown in FIG. 7, there are three transport conveyances (conveyor 118A, conveyor 118B, and conveyor 118C) used to transport merchandise in containers 116 to the corresponding merchandise order assembly area 106 (although they might not all be needed in other examples). As should be evident, other arrangements and purposes for multiple merchandise order assembly areas (or stations) 106 about the shopping facility 102 are also possible.

In one form, it is also contemplated that the system 100 will confirm that the transfer of a merchandise item 146 by a robotic device 144 has been successfully completed. If not successfully completed, the system 100 may then make a second attempt at transfer using a different end effector 145. Accordingly, in this form, the image sensor 148 is configured to capture images of an attempted pick up of the merchandise item 146 by the selected end effector 145. Further, the control circuit 124 is configured to receive, from the image sensor 148, the images of the attempted pick up of the merchandise item 146 by the selected end effector 145 and determine if the selected end effector 145 has successfully picked up the merchandise item 146. The image sensor 148 is directed generally at the location where the robotic device 144 is picking up the merchandise item 146, so it is generally contemplated that it will also be able to capture images to determine whether the attempted pick up and transfer was successfully completed. If not successful, it is generally contemplated that the approach can generally be re-attempted (in the manner described above) but using a different end effector 145. So, if the merchandise item 146 has not successfully picked up the merchandise item 146, the control circuit is configured to: determine an updated orientation of the merchandise item 146 relative to the robotic device 144; determine, from the merchandise database 150, the set of surface areas of the merchandise item 146 suitable for engagement with end effectors 145; determine one of the set of surface areas of the merchandise item 146 suitable for engagement based, at least in part, on the updated orientation of the merchandise item 146 relative to the robotic device 144; select a different end effector 145 of the robotic device 144 to be used to engage the merchandise item 146; instruct movement of the robotic device 144 so as to cause the different end effector 145 to engage the determined surface area of the merchandise item 146; and instruct, following engagement of the different end effector 145 with the determined surface area of the merchandise item 146, movement of the robotic device 144 to transfer the merchandise item 146 to the receiving location.

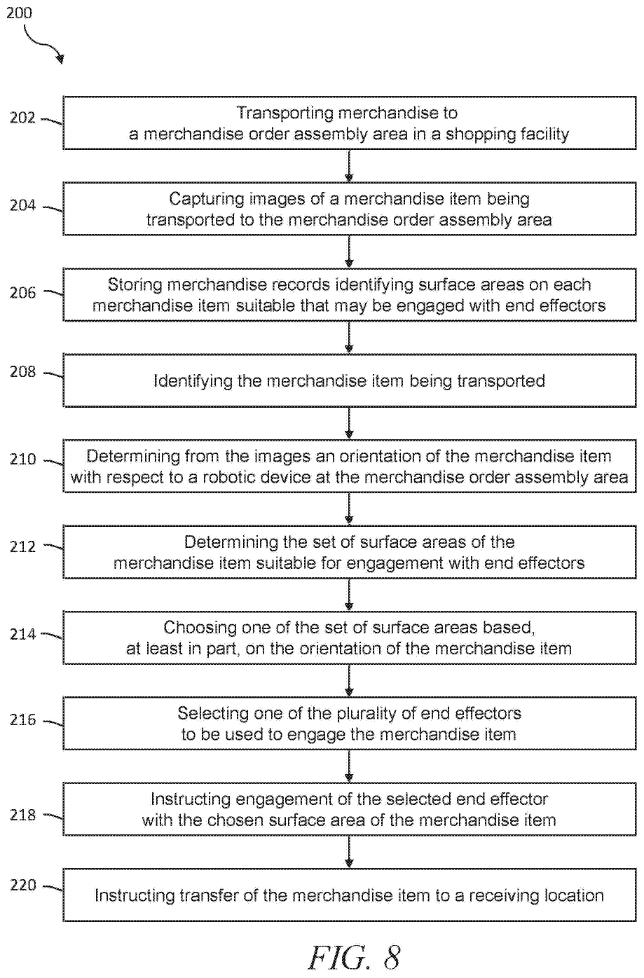

Referring to FIG. 8, there is shown a process 200 for picking up and transferring a variety of different types of merchandise in shopping facilities. In one form, the process 200 may be used to facilitate assembly of an order placed by a customer for pick up at a shopping facility. It is generally contemplated that the process 200 may use some or all of the components described above with respect to system 100.

At block 202, merchandise is transported to a merchandise order assembly area in a shopping facility. It is generally contemplated that the shopping facility includes a merchandise order assembly area configured for assembly of part or all of a merchandise order. Further, it is generally contemplated that some or all of the merchandise in the order may be transported by an automated retrieval system at the shopping facility to the merchandise order assembly area. In one form, some or all of the merchandise in the order may be transported from a merchandise storage area to the merchandise order assembly area. Further, in one form, the merchandise may be transported in storage containers (or storage totes).

At block 204, images of a merchandise item being transported to the merchandise order assembly area are captured. It is generally contemplated that an image sensor is positioned and oriented in a manner so as to capture images of the merchandise item when it is in proximity to a robotic device at the merchandise order assembly area. This robotic device is arranged to pick up and move the merchandise item to a receiving location. It includes a plurality of end effectors mounted to the robotic device with each end effector configured to engage predetermined surfaces of different types of merchandise.

At block 206, a plurality of records of some or all of the merchandise located at the shopping facility is stored. It is generally contemplated that that this action may be performed prior to the assembly of any order and may be updated on a regular basis thereafter. Each merchandise record identifies a set of surface areas on a particular merchandise item corresponding to one or more end effectors and suitable for engagement with corresponding end effector(s). In general, these records indicate where a merchandise item may be picked up and with what end effector(s). For example, these records may include mapping of the surface areas of the merchandise that may include “pick” regions (and associated end effectors) and “no-pick” regions.

At block 208, the merchandise item being transported is identified. It is generally contemplated that the merchandise item is identified at one of various stages and in various ways. For example, a barcode or other identification label may be scanned or read at any of various locations (such as at a merchandise storage area, at or on a transport conveyance, or at the merchandise order assembly area). Alternatively, as another example, the merchandise item may be identified base on the images captured by the image sensor.

At block 210, an orientation of the merchandise item with respect to the robotic device is determined from the images. If the merchandise item is in a storage container or tote, its orientation within this container is determined. As addressed below, this orientation is generally used to determine the surface areas of the merchandise item that are accessible and available for engagement and, in turn, the corresponding end effectors on the robotic device that may be utilized.

At block 212, the set of surface areas of the merchandise item suitable for engagement with end effectors is determined. It is generally contemplated that this determination is based, at least in part, on existing merchandise records in which this information has been stored. At block 214, one of the set of surface areas is chosen based, at least in part, on the orientation of the merchandise item. So, for example, the merchandise item may be right-side-up, upside down, on one of its side surfaces, or in a canted position, and this orientation helps determine the surface area of the merchandise item available to be utilized for pick up.

At block 216, one of the plurality of end effectors is selected to be used to engage the merchandise item. For example, if only one surface area is available for pick up based on merchandise orientation and only one end effector is associated with that surface area, then that particular end effector is selected. However, in some instances, there may be multiple end effectors associated with a surface area and there may be multiple surface areas that are available for engagement, and in these instances, selection may be based on an algorithm. For example, each location on the surface of the merchandise item may have a primary end effector (or primary picker) associated with that location that is to be used if available and may include alternative or secondary end effectors that may be used if the primary end effector is not available.

In some forms, it is contemplated that the selection of end effectors may involve a machine learning approach to continually improve selection. For example, the process 200 may use a supervised learning approach in which it infers weights to be given to various end effectors based on a number of pick up attempts and the outcomes of these attempts. As one example, this approach may observe the use of a primary end effector over many pick up attempts and may adjust the status based on performance (i.e., downgrade the primary end effector status if it exceeds a certain threshold of failures or maintain its status if it performs successfully). Similarly, a secondary or alternative end effector may be upgraded if it has a high percentage of successful transfers. Further, in one form, the performance of an end effector for one type of merchandise item may then be used to predict its performance for other merchandise items with similar surfaces. Accordingly, in one form, it is contemplated that information regarding actual performance (successes and failures) is used to continually adjust the approach for selection of end effectors. Additionally, however, the selection of end effectors will also involve predictions and forecasting based on the similarity of features of various merchandise items (even in the absence of performance information).

Block 218 shows the next action following selection of an end effector. At block 218, engagement of the selected end effector with the chosen surface area of the merchandise item is instructed. Then, at block 220, transfer of the merchandise item to a receiving location is instructed. In one form, it is contemplated that the receiving location may be an order tote or container that is intended for pick up by the customer.

The process 200 may also involve the use of multiple robotic devices in a number of different arrangements and approaches. For example, in one form, the approach may begin with a camera or other image sensor oriented to view into a container, which may be, for example, moving on a conveyor or being transported to a station for filling/assembling the order. The control circuit determines the orientation of the products in the container and then chooses the appropriate robot with the appropriate end effector. If the product is sent to a first robot and there is difficulty picking, the control circuit may dictate a different end effector. This difficulty may happen when items are stacked or leaning on each other in the container, such that when one is removed the other tips over, etc. In this example, the process 200 may decide whether or not it is more efficient (based on throughput time) to change the end effector at the current (first) robot if that robot is not equipped with the end effector or to send the container to a second robot with the appropriate end effector already attached. This determination may be made based on speed, i.e., the action is taken that will result in the quickest throughput.

The above description of system 100 and process 200 generally involves a shopping facility and an automated retrieval system. In other forms, however, the subject matter disclosed herein does not involves these objects. In other words, this disclosure also contemplates systems and methods for using a robotic device to pick up merchandise of various sizes, shapes, and orientations but not necessarily in a shopping facility and not necessarily involving an automated retrieval system (such as a conveyor).

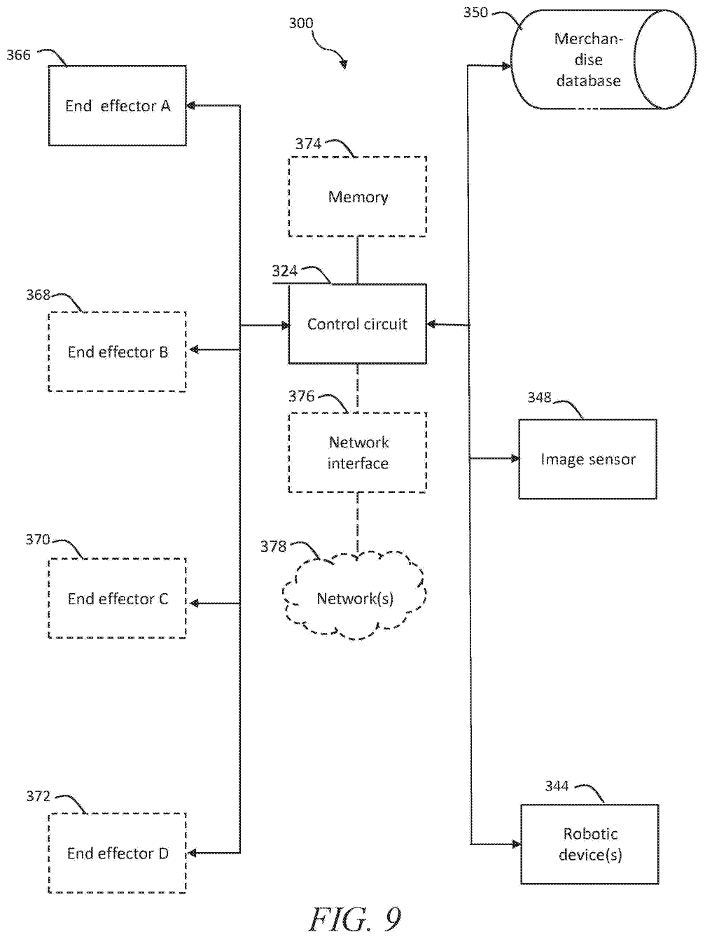

Referring to FIG. 9, there is shown a system 300 for picking up and transferring a variety of different types of merchandise. For example, system 300 may apply where all of the merchandise is provided to stations with robotic device(s) manually by individuals (rather than by automated retrieval). It is generally contemplated that the system 300 may use some of the components described above with respect to system 100, and the description of system 100 and process 200 are incorporated herein.

The system 300 includes an image sensor 348 that captures images of a merchandise item. These images help determine the orientation of the merchandise item. The system 300 further includes robotic device(s) 344 that pick up and move the merchandise item. The robotic device(s) 344 include a plurality of end effectors (such as end effector A 366, end effector B 368, end effector C 370, and/or end effector D 372) mounted to the robotic device(s) 344. Each end effector is intended and suited to engage predetermined surfaces of different types of merchandise. The system 300 also includes a merchandise database 350 containing a merchandise records identifying surface areas on the merchandise corresponding to each end effector and suitable for engagement with the corresponding end effector. The merchandise database 350 may include a map of “pick” regions (and associated end effectors) and “no-pick” regions.

In addition, the system 300 includes a control circuit 324 that generally governs the operation of the system 300. The control circuit 324 may be communicatively coupled to a memory 374, a network interface 376, and network 378 so as to facilitate the functions and operations it performs. During operation, the control circuit 324 identifies the merchandise item to be engaged and transferred; receives images of the merchandise item from the image sensor 348; determines an orientation of the merchandise item relative to a robotic device 344; determines from the merchandise database 350 the surface areas of the merchandise item suitable for engagement with end effectors; chooses one of the surface areas based, at least in part, on the orientation of the merchandise item relative to the robotic device 344; selects one of the end effectors for use; instructs movement of the robotic device 344 so as to cause the selected end effector to engage the chosen surface area of the merchandise item; and instructs movement of the robotic device 344 to transfer the merchandise item to a receiving location.

Those skilled in the art will recognize that a wide variety of other modifications, alterations, and combinations can also be made with respect to the above described embodiments without departing from the scope of the invention, and that such modifications, alterations, and combinations are to be viewed as being within the ambit of the inventive concept.

What is claimed is:

1. A system for picking up and transferring a variety of different types of merchandise in shopping facilities, the system comprising:
a shopping facility comprising a merchandise order assembly area configured for assembly of part or all of a merchandise order;
an automated retrieval system configured to retrieve and transport merchandise to the merchandise order assembly area;
an image sensor configured to capture images of a merchandise item being transported to the merchandise order assembly area;
at least one robotic device at the merchandise order assembly area configured to pick up and move the merchandise item, the at least one robotic device including a plurality of end effectors mounted to the at least one robotic device, each type of end effector configured to engage predetermined surfaces of different types of merchandise;
a merchandise database containing a plurality of records of merchandise at the shopping facility, each merchandise record identifying a set of surface areas on the merchandise corresponding to each end effector and suitable for engagement with the corresponding end effector;
a control circuit communicatively coupled to the image sensor, the at least one robotic device, and the merchandise database, the control circuit configured to:
identify the merchandise item being transported to the merchandise order assembly area;
receive, from the image sensor, the images of the merchandise item being transported to the merchandise order assembly area;
determine, from the images, an orientation of the merchandise item relative to the at least one robotic device;
determine, from the merchandise database, the set of surface areas of the merchandise item suitable for engagement with end effectors;
choose one of the set of surface areas of the merchandise item suitable for engagement based, at least in part, on the orientation of the merchandise item relative to the at least one robotic device;
select one of the plurality of end effectors of the at least one robotic device to be used to engage the merchandise item;
instruct movement of the at least one robotic device so as to cause the selected end effector to engage the chosen surface area of the merchandise item;
instruct, following engagement of the selected end effector with the chosen surface area of the merchandise item, movement of the at least one robotic device to transfer the merchandise item to a receiving location.

2. The system of claim 1, wherein the automated retrieval system comprises:
a plurality of containers configured to contain merchandise in a merchandise storage area in the shopping facility; and
a transport conveyance configured to transport containers between the merchandise storage area and the merchandise order assembly area.

3. The system of claim 2, wherein the transport conveyance comprises at least one of a conveyor assembly and an autonomous ground vehicle.

4. The system of claim 1, further comprising a plurality of robotic devices and a plurality of merchandise order assembly areas in the shopping facility, each merchandise order assembly area corresponding to a different range of merchandise transported to that merchandise order assembly area.

5. The system of claim 4, further comprising:
a first robotic device in a first merchandise order assembly area configured for pick up and transfer of merchandise in a first, ambient temperature range;
a second robotic device in a second merchandise order assembly area configured for pick up and transfer of merchandise in a second, chilled temperature range; and
a third robotic device in a third merchandise order assembly area configured for pick up and transfer of merchandise in a third, frozen temperature range.

6. The system of claim 1, wherein the plurality of end effectors comprises at least one of a plurality of suction cups of different sizes and a plurality of grasping arms with fingers of different lengths.

7. The system of claim 1, wherein each merchandise record identifies a no pickup set of surface areas on the merchandise item for surface areas that are not suitable for engagement.

8. The system of claim 1, further comprising a plurality of robotic devices at the merchandise order assembly area, each robotic device including a different, predetermined set of end effectors mounted to each robotic device;
wherein the control circuit is configured to select and instruct one of the plurality of robotic devices to pick up and transfer the merchandise item.

9. The system of claim 1, wherein:
the image sensor is configured to capture images of an attempted pick up of the merchandise item by the selected end effector;
the control circuit is configured to:
receive, from the image sensor, the images of the attempted pick up of the merchandise item by the selected end effector;
determine if the selected end effector has successfully picked up the merchandise item; and
if the merchandise item has not successfully picked up the merchandise item:
determine an updated orientation of the merchandise item relative to the at least one robotic device;
determine, from the merchandise database, the set of surface areas of the merchandise item suitable for engagement with end effectors;
determine one of the set of surface areas of the merchandise item suitable for engagement based, at least in part, on the updated orientation of the merchandise item relative to the at least one robotic device;
select a different end effector of the at least one robotic device to be used to engage the merchandise item;
instruct movement of the at least one robotic device so as to cause the different end effector to engage the determined surface area of the merchandise item; and
instruct, following engagement of the different end effector with the determined surface area of the merchandise item, movement of the at least one robotic device to transfer the merchandise item to the receiving location.

10. A method for picking up and transferring a variety of different types of merchandise in shopping facilities, the method comprising:
providing a merchandise order assembly area in a shopping facility configured for assembly of part or all of a merchandise order;
retrieving and transporting merchandise to the merchandise order assembly area;
capturing images of a merchandise item being transported to the merchandise order assembly area;
by at least one robotic device at the merchandise order assembly area, picking up and moving the merchandise item, the at least one robotic device including a plurality of end effectors mounted to the at least one robotic device, each type of end effector configured to engage predetermined surfaces of different types of merchandise;
storing a plurality of records of merchandise at the shopping facility, each merchandise record identifying a set of surface areas on the merchandise corresponding to each end effector and suitable for engagement with the corresponding end effector;
by a control circuit:
identifying the merchandise item being transported to the merchandise order assembly area;
receiving the images of the merchandise item being transported to the merchandise order assembly area;
determining, from the images, an orientation of the merchandise item relative to the at least one robotic device;
determining the set of surface areas of the merchandise item suitable for engagement with end effectors;
choosing one of the set of surface areas of the merchandise item suitable for engagement based, at least in part, on the orientation of the merchandise item relative to the at least one robotic device;
selecting one of the plurality of end effectors of the at least one robotic device to be used to engage the merchandise item;
instructing movement of the at least one robotic device so as to cause the selected end effector to engage the chosen surface area of the merchandise item; and
instructing, following engagement of the selected end effector with the chosen surface area of the merchandise item, movement of the at least one robotic device to transfer the merchandise item to a receiving location.

11. The method of claim 10, wherein the automated retrieval system comprises:
a plurality of containers configured to contain merchandise in a merchandise storage area in the shopping facility; and
a transport conveyance configured to transport containers between the merchandise storage area and the merchandise order assembly area.

12. The method of claim 11, wherein the transport conveyance comprises at least one of a conveyor assembly and an autonomous ground vehicle.

13. The method of claim 10, further comprising a plurality of robotic devices and a plurality of merchandise order assembly areas in the shopping facility, each merchandise order assembly area corresponding to a temperature range of merchandise transported to the merchandise order assembly area.

14. The method of claim 13, further comprising:
by a first robotic device in a first merchandise order assembly area, picking up and transferring merchandise in a first, ambient temperature range;
by a second robotic device in a second merchandise order assembly area, picking up and transferring merchandise in a second, chilled temperature range; and
by a third robotic device in a third merchandise order assembly area, picking up and transferring merchandise in a third, frozen temperature range.

15. The method of claim 10, wherein the plurality of end effectors comprises at least one of a plurality of suction cups of different sizes and a plurality of grasping arms with fingers of different lengths.

16. The method of claim 10, wherein each merchandise record identifies a no pickup set of surface areas on the merchandise identifying surface areas that are not suitable for engagement.

17. The method of claim 10, further comprising a plurality of robotic devices at the merchandise order assembly area, each robotic device including a different, predetermined set of end effectors mounted to each robotic device; and
by the control circuit, selecting and instructing one of the plurality of robotic devices to pick up and transfer the merchandise item.

18. The method of claim 10, further comprising:
capturing images of an attempted pick up of the merchandise item by the selected end effector;
by the control circuit:
receiving the images of the attempted pick up of the merchandise item by the selected end effector;
determining if the selected end effector has successfully picked up the merchandise item; and
if the merchandise item has not successfully picked up the merchandise item:
determining an updated orientation of the merchandise item relative to the at least one robotic device;
determining the set of surface areas of the merchandise item suitable for engagement with end effectors;
determining one of the set of surface areas of the merchandise item suitable for engagement based, at least in part, on the updated orientation of the merchandise item relative to the at least one robotic device;
selecting a different end effector of the at least one robotic device to be used to engage the merchandise item;
instructing movement of the at least one robotic device so as to cause the different end effector to engage the determined surface area of the merchandise item; and
instructing, following engagement of the different end effector with the determined surface area of the merchandise item, movement of the at least one robotic device to transfer the merchandise item to the receiving location.

19. A system for picking up and transferring a variety of different types of merchandise, the system comprising:
an image sensor configured to capture images of a merchandise item;
at least one robotic device configured to pick up and move the merchandise item, the at least one robotic device including a plurality of end effectors mounted to the at least one robotic device, each type of end effector configured to engage predetermined surfaces of different types of merchandise;
a merchandise database containing a plurality of records of merchandise, each merchandise record identifying a set of surface areas on the merchandise corresponding to each end effector and suitable for engagement with the corresponding end effector;
a control circuit communicatively coupled to the image sensor, the at least one robotic device, and the merchandise database, the control circuit configured to:
identify the merchandise item;
receive, from the image sensor, the images of the merchandise item;
determine, from the images, an orientation of the merchandise item relative to the at least one robotic device;
determine, from the merchandise database, the set of surface areas of the merchandise item suitable for engagement with end effectors;
choose one of the set of surface areas of the merchandise item suitable for engagement based, at least in part, on the orientation of the merchandise item relative to the at least one robotic device;
select one of the plurality of end effectors of the at least one robotic device to be used to engage the merchandise item;
instruct movement of the at least one robotic device so as to cause the selected end effector to engage the chosen surface area of the merchandise item; and
instruct, following engagement of the selected end effector with the chosen surface area of the merchandise item, movement of the at least one robotic device to transfer the merchandise item to a receiving location.

20. The system of claim 19, further comprising an automated retrieval system configured to retrieve and transport merchandise to the at least one robotic device.
